(19) United States
(12) Patent Application Publication
(10) Pub. No.: US 2013/0154395 A1
(43) Pub. Date: Jun. 20, 2013

(54) SOLAR INVERTER SYSTEM AND CONTROL METHOD THEREOF

(71) Applicant: DARFON ELECTRONICS CORP., Taoyuan (TW)

(72) Inventors: Chang-Chia Chiang, Taoyuan (TW); Li Hsiang, Taoyuan (TW); Hsiao-Chih Ku, Taoyuan (TW)

(73) Assignee: DARFON ELECTRONICS CORP., Taoyuan (TW)

(21) Appl. No.: 13/710,469

(22) Filed: Dec. 11, 2012

(30) Foreign Application Priority Data
Dec. 19, 2011 (TW) 100147069

(51) Int. Cl. H02M 7/44

(52) U.S. Cl. CPC H02M 7/44
USPC 307/151

(57) ABSTRACT

A control method of a solar inverter system includes calculating total output power outputted by a first inverter and a second inverter; determining whether the total output power is less than a threshold value; and executing a corresponding operation according to a determination result.

### BACKGROUND OF THE INVENTION

1. Field of the Invention

The present invention relates to a solar inverter system and a control method, and particularly to a solar inverter system and a control method that can utilize a controller to control output power of inverters included in the solar inverter system to increase efficiency of the solar inverter system and decrease harmonic distortion of the solar inverter system.

2. Description of the Prior Art

Generally speaking, when output power of an inverter is lower (e.g. the output power of the inverter is lower than 30% maximum output power of the inverter), efficiency and harmonic distortion of the solar inverter system including the inverter are worse. In a solar inverter system with multi-inverters, because total output power of the solar inverter system is evenly distributed to each inverter (that is, output power of each inverter is the same), output power of each inverter is much lower, resulting in efficiency and harmonic distortion of the solar inverter system with multi-inverters being much worse. Those skilled in the art can refer to U.S. Pat. No. 7,893,346 and U.S. Pat. No. 8,013,472.

Therefore, in the solar inverter system with multi-inverters, the efficiency and the harmonic distortion of the solar inverter system with multi-inverters are usually worse than a solar inverter system with an inverter because each inverter of the solar inverter system with multi-inverters outputs the same power.

### SUMMARY OF THE INVENTION

An embodiment provides a control method of a solar inverter system. The solar inverter system includes a first inverter, a second inverter, and a controller. The first inverter and the second inverter are connected in parallel with an alternating current (AC) line network. The controller optionally controls the first inverter to output total output power alone, or controlling the first inverter and the second inverter to simultaneously output the total output power. The control method includes calculating the total output power outputted by the first inverter and the second inverter; determining whether the total output power is less than a threshold value; and executing a corresponding operation according to a determination result.

Another embodiment provides a solar inverter system. The solar inverter system includes a first inverter, a second inverter, and a controller. The first inverter has a first input terminal and a first output terminal, where the first input terminal is coupled to a solar panel. The second inverter has a second input terminal and a second output terminal, where the second input terminal is coupled to the solar panel, and the first output terminal and the second output terminal are connected in parallel with an AC line network. The controller is coupled to the first inverter and the second inverter, where the controller is used for optionally controlling the first inverter to output total output power alone, or controlling the first inverter and the second inverter to simultaneously output the total output power.

The present invention provides a solar inverter system and a control method thereof. The solar inverter system and the control method utilize a controller to calculate total output power of the solar inverter system, and determine whether the total output power of the solar inverter system is less than a threshold value. Then, when the total output power of the solar inverter system is less than the threshold value, the controller controls a first inverter to output the total output power of the solar inverter system alone; when the total output power of the solar inverter system is greater than the threshold value, the controller controls the first inverter and a second inverter to simultaneously output the total output power of the solar inverter system. Compared to the prior art, because efficiency and harmonic distortion of the solar inverter system is determined by an inverter (included in the solar inverter system) with greater output power, the solar inverter system provided by the present invention has better efficiency and lower harmonic distortion.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a solar inverter system according to an embodiment.

FIG. 2 is a diagram illustrating a solar inverter system according to another embodiment.

FIG. 3 is a flowchart illustrating a control method of a solar inverter system according to another embodiment.

### DETAILED DESCRIPTION

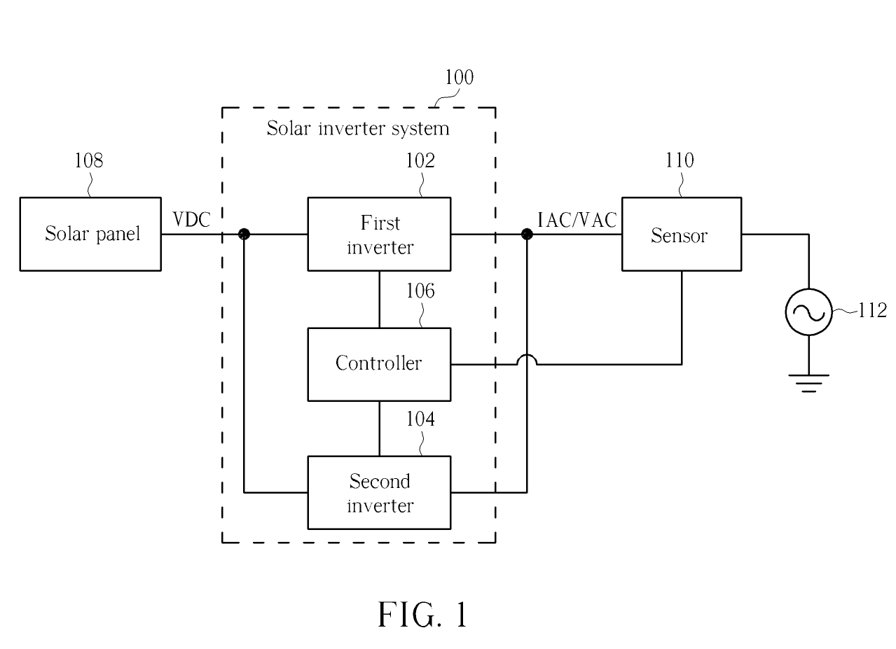

Please refer to FIG. 1. FIG. 1 is a diagram illustrating a solar inverter system 100 according to an embodiment. The solar inverter system 100 includes a first inverter 102, a second inverter 104, and a controller 106, where the first inverter 102 and the second inverter 104 are the same, but the first inverter 102 can be also different from the second inverter 104. But, the present invention is not limited to the solar inverter system 100 only including the first inverter 102 and the second inverter 104. That is to say, the solar inverter system 100 can include at least two inverters. The first inverter 102 has a first input terminal and a first output terminal, where the first input terminal is coupled to a solar panel 108. The second inverter 104 has a second input terminal and a second output terminal, where the second input terminal is coupled to the solar panel 108. As shown in FIG. 1, the first output terminal of the first inverter 102 and the second output terminal of the second inverter 104 are connected in parallel with an alternating current (AC) line network 112 through a sensor 110, where the sensor 110 is used for sensing an AC current IAC and an AC voltage VAC generated by the first inverter 102 and the second inverter 104 converting a direct current voltage VDC of the solar panel 108. In addition, the AC line network 112 has an AC frequency (e.g. 50 Hz or 60 Hz) and an AC voltage (e.g. 110V or 220V). The controller 106 is coupled to the first inverter 102, the second inverter 104, and the sensor 110, where the controller 106 is used for calculating total output power of the solar inverter system 100 according to the AC current IAC and the AC voltage VAC.

When the total output power of the solar inverter system 100 is less than a threshold value (that is, maximum output power of the first inverter 102), the controller 106 controls the first inverter 102 to output the total output power of the solar inverter system 100 alone; when the total output power of the solar inverter system 100 is greater than the threshold value, the controller 106 controls the first inverter 102 and the second inverter 104 to simultaneously output the total output power of the solar inverter system 100, where output power of the first inverter 102 is equal to the maximum output power of the first inverter 102, and output power of the second inverter 104 is equal to the total output power of the solar inverter system 100 minus the maximum output power of the first inverter.

For example, the maximum output power of the first inverter is equal to 120 W. When the total output power of the solar inverter system 100 is 110 W, because the total output power (110 W) of the solar inverter system 100 is less than the threshold value (120 W), the controller 106 controls the first inverter 102 to output the total output power (110 W) of the solar inverter system 100 alone; when the total output power of the solar inverter system 100 is 130 W, because the total output power (130 W) of the solar inverter system 100 is greater than the threshold value (120 W), the controller 106 controls the first inverter 102 and the second inverter 104 to simultaneously output the total output power (130 W) of the solar inverter system 100. Meanwhile, the output power of the first inverter 102 is equal to the maximum output power (120 W) of the first inverter 102, and the output power of the second inverter 104 is equal to the total output power (130 W) of the solar inverter system 100 minus the maximum output power (120 W) of the first inverter 102. That is to say, the output power of the second inverter 104 is equal to 10 W.

In addition, in another embodiment of the present invention, the solar inverter system 100 further includes the sensor 110.

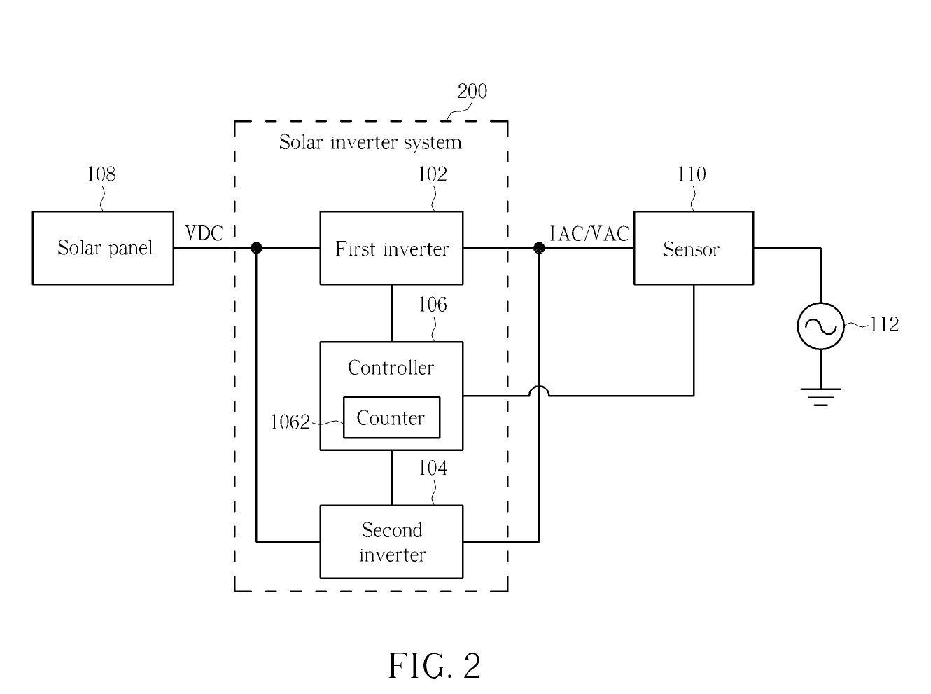

Please refer to FIG. 2. FIG. 2 is a diagram illustrating a solar inverter system 200 according to another embodiment. A difference between the solar inverter system 200 and the solar inverter system 100 is that the controller 106 includes a counter 1062, where the counter 1062 is used for counting a number of total output power of the solar inverter system 200 being greater than the threshold value (120 W) within a predetermined period. When the number is not greater than N (N is a positive integer), the controller 106 controls the first inverter 102 to output the total output power of the solar inverter system 200 alone; when the number is greater than N, the controller 106 controls the first inverter 102 and the second inverter 104 to simultaneously output the total output power of the solar inverter system 200, where the output power of the first inverter 102 is equal to the maximum output power (120 W) of the first inverter 102, and the output power of the second inverter 104 is equal to the total output power of the solar inverter system 200 minus the maximum output power (120 W) of the first inverter 102. In addition, in another embodiment of the present invention, the solar inverter system 200 further includes the sensor 110. In addition, subsequent operational principles of the solar inverter system 200 are the same as those of the solar inverter system 100, so further description thereof is omitted for simplicity.

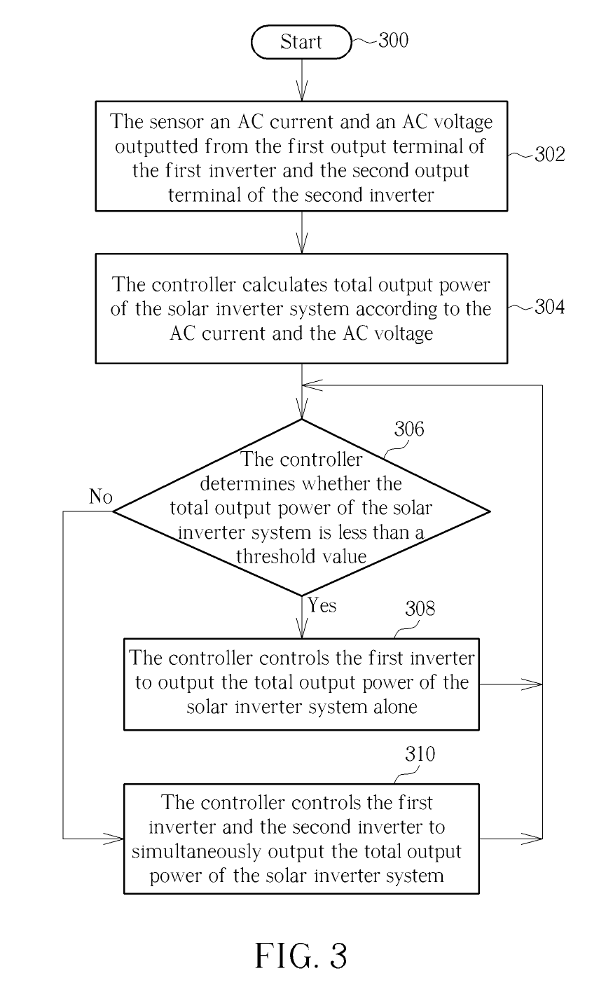

Please refer to FIG. 1, FIG. 2, and FIG. 3. FIG. 3 is a flowchart illustrating a control method of a solar inverter system according to another embodiment. The method in FIG. 3 is illustrated using the solar inverter system 100 in FIG. 1. Detailed steps are as follows:

Step 300: Start.

Step 302: The sensor 110 senses an AC current IAC and an AC voltage VAC outputted from the first output terminal of the first inverter 102 and the second output terminal of the second inverter 104.

Step 304: The controller 106 calculates total output power of the solar inverter system 100 according to the AC current IAC and the AC voltage VAC.

Step 306: The controller 106 determines whether the total output power of the solar inverter system 100 is less than a threshold value; if yes, go to Step 308; if no, go to Step 310.

Step 308: The controller 106 controls the first inverter 102 to output the total output power of the solar inverter system 100 alone; go to Step 306.

Step 310: The controller 106 controls the first inverter 102 and the second inverter 104 to simultaneously output the total output power of the solar inverter system 100; go to Step 306.

In Step 306, the threshold value is equal to the maximum output power of the first inverter 102. In Step 308, when the total output power of the solar inverter system 100 is less than the threshold value, the controller 106 controls the first inverter 102 to output the total output power of the solar inverter system 100 alone. For example, the maximum output power of the first inverter is equal to 120 W. when the total output power of the solar inverter system 100 is 110 W, because the total output power (110 W) of the solar inverter system 100 is less than the threshold value (120 W), the controller 106 controls the first inverter 102 to output the total output power (110 W) of the solar inverter system 100 alone. In Step 310, when the total output power of the solar inverter system 100 is greater than the threshold value, the controller 106 controls the first inverter 102 and the second inverter 104 to simultaneously output the total output power of the solar inverter system 100, where the output power of the first inverter 102 is equal to the maximum output power of the first inverter 102, and the output power of the second inverter 104 is equal to the total output power of the solar inverter system 100 minus the maximum output power of the first inverter 102. For example, when the total output power of the solar inverter system 100 is 130 W, because the total output power (130 W) of the solar inverter system 100 is greater than the threshold value (120 W), the controller 106 controls the first inverter 102 and the second inverter 104 to simultaneously output the total output power (130 W) of the solar inverter system 100, where the output power of the first inverter 102 is equal to the maximum output power (120 W) of the first inverter 102, and the output power of the second inverter 104 is equal to the total output power (130 W) of the solar inverter system 100 minus the maximum output power (120 W) of the first inverter 102. That is to say, the output power of the second inverter 104 is equal to 10 W.

In addition, in another embodiment of the present invention, in Step 306, the controller 106 of the solar inverter system 200 determines whether a number (counted by the counter 1062) of total output power of the solar inverter system 200 being greater than the threshold value (120 W) within a predetermined period is greater than N (N is a positive integer). When the number is not greater than N, the controller 106 controls the first inverter 102 to output the total output power of the solar inverter system 200 alone; when the number is greater than N, the controller 106 controls the first inverter 102 and the second inverter 104 to simultaneously output the total output power of the solar inverter system 200, where the output power of the first inverter 102 is equal to the maximum output power (120 W) of the first inverter 102, and the output power of the second inverter 104 is equal to the total output power of the solar inverter system 200 minus the maximum output power (120 W) of the first inverter 102.

To sum up, the solar inverter system and the control method thereof utilize the controller to calculate total output power of the solar inverter system, and determine whether the total output power of the solar inverter system is less than a threshold value. Then, when the total output power of the solar inverter system is less than the threshold value, the controller controls the first inverter to output the total output power of the solar inverter system alone; when the total output power of the solar inverter system is greater than the threshold value, the controller controls the first inverter and the second inverter to simultaneously output the total output power of the solar inverter system. Compared to the prior art, because efficiency and harmonic distortion of the solar inverter system is determined by an inverter (included in the solar inverter system) with greater output power, the solar inverter system provided by the present invention has better efficiency and lower harmonic distortion.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control method of a solar inverter system, the solar inverter system comprising a first inverter, a second inverter, and a controller, the first inverter and the second inverter being connected in parallel with an alternating current (AC) line network, the controller optionally controlling the first inverter to output total output power alone, or controlling the first inverter and the second inverter to simultaneously output the total output power, the control method comprising:
calculating the total output power outputted by the first inverter and the second inverter;
determining whether the total output power is less than a threshold value; and
executing a corresponding operation according to a determination result.

2. The control method of claim 1, wherein executing the corresponding operation according to the determination result is the controller controlling the first inverter to output the total output power alone when the total output power is less than the threshold value.

3. The control method of claim 1, wherein executing the corresponding operation according to the determination result is the controller controlling the first inverter and the second inverter to simultaneously output the total output power when the total output power is greater than the threshold value, wherein output power of the first inverter is equal to maximum output power of the first inverter, and output power of the second inverter is equal to the total output power minus the maximum output power of the first inverter.

4. The control method of claim 1, wherein a first output terminal of the first inverter and a second output terminal of the second inverter are coupled to a sensor, wherein calculating the total output power outputted by the first inverter and the second inverter comprising:
the sensor sensing an AC current and an AC voltage outputted from the first output terminal and the second output terminal; and
the controller calculating the total output power according to the AC current and the AC voltage.

5. The control method of claim 1, wherein the controller comprises a counter for counting a number of the total output power being greater than the threshold value within a predetermined period, wherein the controller controls the first inverter and the second inverter to simultaneously output the total output power when the number is greater than N, wherein output power of the first inverter is equal to maximum output power of the first inverter, and output power of the second inverter is equal to the total output power minus the maximum output power of the first inverter.

6. A solar inverter system, comprising:
a first inverter having a first input terminal, and a first output terminal, wherein the first input terminal is coupled to a solar panel;
a second inverter having a second input terminal, and a second output terminal, wherein the second input terminal is coupled to the solar panel, and the first output terminal and the second output terminal are connected in parallel with an AC line network; and
a controller coupled to the first inverter and the second inverter, wherein the controller is used for optionally controlling the first inverter to output total output power alone, or controlling the first inverter and the second inverter to simultaneously output the total output power.

7. The solar inverter system of claim 6, wherein the controller controls the first inverter to output the total output power alone when the total output power is less than a threshold value.

8. The solar inverter system of claim 6, wherein the controller controls the first inverter and the second inverter to simultaneously output the total output power when the total output power is greater than the threshold value, wherein output power of the first inverter is equal to maximum output power of the first inverter, and output power of the second inverter is equal to the total output power minus the maximum output power of the first inverter.

9. The solar inverter system of claim 6, wherein a first output terminal of the first inverter and a second output terminal of the second inverter are coupled to a sensor, wherein the sensor is used for sensing an AC current and an AC voltage outputted from the first output terminal and the second output terminal, and the controller calculates the total output power according to the AC current and the AC voltage.

10. The solar inverter system of claim 6, wherein the controller comprises a counter for counting a number of the total output power being greater than the threshold value within a predetermined period, and the controller controls the first inverter and the second inverter to simultaneously output the total output power when the number is greater than N, wherein output power of the first inverter is equal to maximum output power of the first inverter, and output power of the second inverter is equal to the total output power minus the maximum output power of the first inverter.
